(19) United States
(12) Patent Application Publication
(10) Pub. No.: US 2019/0136834 A1
(43) Pub. Date: May 9, 2019

(54) METHOD FOR SEPARATING A DRIED FIBER COMPOSITE FABRIC, USE OF A SEPARATING DEVICE FOR SEPARATING A DRIED FIBER COMPOSITE FABRIC, AND A WIND TURBINE

(71) Applicant: Wobben Properties GmbH, Aurich (DE)

(72) Inventors: Andrea GRAVEMANN, Emden (DE); Harald WESTRUP, Büren (DE)

(21) Appl. No.: 16/300,373

(22) PCT Filed: May 12, 2017
(86) PCT No.: PCT/EP2017/061442

§ 371 Date: Nov. 9, 2018

(30) Foreign Application Priority Data
May 12, 2016 (DE) 10 2016 108 785.8

(51) Int. Cl. F03D 13/10; B23D 61/12; B26D 1/10; B26D 3/00

(52) U.S. Cl. CPC F03D 13/10; B23D 61/121; B26D 2001/006; B26D 3/006; F05B 2230/10; B26D 1/10

(57) ABSTRACT

A method for separating a dry fiber composite fabric, to a use of a separating device for separating a dry fiber composite fabric and to a wind power installation. A method for separating a dry fiber composite fabric with a multiplicity of fabric layers arranged one on top of the other, comprising providing the dry fiber composite fabric and a separating device, separating the dry fiber composite fabric with the separating device, which comprises a separating element with a toothing, wherein the toothing has a wave profile with a plurality of teeth, wherein the separating is performed by a substantially translational movement of the toothing on and/or in the dry fiber composite fabric with a stroke that is greater than a tooth tip spacing of two adjacent teeth of the toothing.

The invention relates to a method for separating a dry fiber composite fabric, to a use of a separating device for separating a dry fiber composite fabric and to a wind power installation.

Fiber composite fabrics are generally a preliminary product for producing fiber composite components. In a further production process, the fiber composite fabrics are generally impregnated with a matrix material, for example an epoxy resin, and further processed to form fiber composite components. Fiber composite fabrics substantially comprise fibers, which may for example be glass fibers and/or aramid fibers and/or carbon fibers. The fibers may preferably be provided as fabric layers. Fabric layers have a two-dimensional extent and, orthogonally thereto, a very small thickness. In addition, fiber composite fabrics often comprise a binder, which holds the fibers and/or the fabric layers together in a defined arrangement. In addition, fiber composite fabrics preferably comprise a multiplicity of fabric layers arranged one on top of the other, so that the thickness of a fiber composite fabric exceeds the thickness of one fiber or one fabric layer by a multiple.

Dry fiber composite fabrics comprise fibers, which have preferably been introduced into the fiber composite fabric as fabric layers, and preferably a binder, which for example is or comprises a synthetic resin, in particular an epoxy resin. The binder may also already be or comprise the matrix material, wherein the proportion of binder in dry fiber composite fabrics is preferably less than the proportion of matrix material in preimpregnated semifinished products or finished fiber composite components. Preferably, the binder has not yet reacted, or only to a slight extent, with further constituents, so that the binder is preferably in a non-hardened, or at least little-hardened state in the dry fiber composite fabric. The fabric layers in the fiber composite fabric may also be connected to one another for example by an adhesive and/or other adhering materials, so that the position of the fabric layers in relation to one another in the fiber composite fabric is substantially maintained even when there are movements of the fiber composite fabric. However, the presence of binders and/or other adhering materials is not a necessity.

By contrast with dry fiber composite fabrics, preimpregnated fiber composite fabrics generally already comprise at least a large part of matrix material. Such semifinished products are for example also referred to as preimpregnated fibers, from which the term prepreg is also derived. Prepregs are therefore distinguished in particular by the fact that they substantially comprise a complete matrix, wherein the matrix has not yet reacted, or only to a slight extent. That is to say in particular that the matrix is not yet cured, or not yet completely cured, and can be connected to a further element by jointly reacting or curing.

Unless otherwise noted explicitly, when mention is made hereinafter of a fiber composite fabric, a dry fiber composite fabric is described. To make up a fiber composite material, a matrix material is introduced into the dry fiber composite fabric, preferably by the infusion process. During the infusion, a dry fiber composite fabric is arranged, sealed with a film and then a vacuum is generated within the fiber composite fabric. After that, the negative pressure in the fiber composite fabric causes the matrix material to pass via a feed line into the fabric and, as a result of the vacuum, it distributes itself extremely homogeneously.

Dry fiber composite fabrics may for example be produced by winding a preliminary product, for example fabric layers, onto a core. In this way, any desired height or thickness of the fiber composite fabric can be achieved. In addition, the fiber composite fabric may in this form already have the geometry of the component to be produced. A height or thickness of the fiber composite fabric is understood here as meaning in particular the extent of the fiber composite fabric orthogonally in relation to a two-dimensional extent of the fiber composite fabric. If the fiber composite fabric is for example provided as tubular, in particular with a circular or elliptical cross section, the height or thickness of the fiber composite fabric preferably extends in a radial direction.

Such fiber composite fabrics are distinguished in particular by the fact that they comprise a multiplicity of fibers arranged next to one another and/or one on top of the other. As a result of the high strength of the fibers contained in the fiber composite fabric, such a fiber composite fabric is generally distinguished by extremely unfavorable separability. In particular, the cutting and/or sawing of such a fiber composite fabric involves particular challenges.

Although it is usually attempted in practice to avoid separating, in particular cutting and/or sawing, such fiber composite fabrics, for example by an appropriate arrangement of the fibers, if required they are generally separated by conventional methods. For example, the separating is performed with an angle grinder.

Apart from tolerances that are often (too) great and a low quality of the cut surfaces, for example due to fraying and/or fusing and/or discoloring of the fibers, separating by means of conventional methods is also distinguished by the fact that it is labor-intensive and also time-consuming, so that, apart from a low quality, there are high costs. Furthermore, frayed cut edges and/or fused fibers make it more difficult to perform an infusion to be carried out after that. Among other things, the desired homogeneous distribution may for example be limited by frayed cut edges or fused fibers.

The German Patent and Trademark Office has searched the following prior art in the priority application for the present application: DE 34 46 899 C1, DE 37 00 250 A1, DE 10 2014 207 785 A1, U.S. Pat. Nos. 3,790,071 A, 4,779,498 A and JP H07-164 378 A.

It is therefore an object of the present invention to provide a method for separating a dry fiber composite fabric, a use of a separating device for separating a dry fiber composite fabric and a wind power installation that reduce or eliminate one or more of the disadvantages mentioned. It is in particular an object of the present invention to provide a method for separating a dry fiber composite fabric and a use of a separating device for separating a dry fiber composite fabric that make a better quality of the cut surfaces possible and/or reduce the costs of separation. Furthermore, it is in particular an object of the present invention to provide a wind power installation that is correspondingly produced with improved quality and/or reduced costs.

The object is achieved according to a first aspect of the invention by a method for separating a dry fiber composite fabric with a multiplicity of fabric layers arranged one on top of the other, comprising providing the dry fiber composite fabric and a separating device, separating the dry fiber composite fabric with the separating device, which comprises a separating element with a toothing, wherein the toothing has a wave profile with a plurality of teeth, wherein the separating comprises a substantially translational movement of the toothing on and/or in the dry fiber composite fabric with a stroke that is greater than a tooth tip spacing of two adjacent teeth of the toothing.

In the fabric layers, the fibers may be arranged parallel and/or at an angle in relation to one another and/or also as multiaxial fabrics. The fibers contained in the fabric layers may for example comprise organic fibers and/or inorganic fibers and/or natural fibers. Inorganic fibers are for example glass fibers, basalt fibers, drill fibers, ceramic fibers or steel fibers. Organic fibers are for example aramid fibers, carbon fibers, polyester fibers or polyethylene fibers, in particular high-performance polyethylene fibers, such as for example Dyneema fibers. Used as natural fibers are for example hemp fibers, flax fibers or sisal fibers. The fiber composite fabrics preferably comprise continuous fibers and/or long fibers and/or short fibers. Fiber composite fabrics and in particular dry fiber composite fabrics are used for example for the production of components of wind power installations.

The invention is based on the realization that dry fiber composite fabrics with a translationally moved separating element, for example a knife and/or a saw blade, have in particular unfavorable separability as a result, since the fibers are not completely spatially fixed in the fabric and therefore can undergo movements. One of the reasons for separating by means of a translationally moved separating element is that a relative movement takes place between the separating element and the element to be separated. A movement of the fibers in the dry fiber composite fabric during the separating process reduces or avoids a relative movement between the separating element and the fibers. This effect is increased the more fabric layers are arranged one on top of the other, that is to say the greater the size of the height of the fiber composite fabric is. In this connection, the height is in particular aligned in the direction of the stroke, so that the height and/or the stroke are preferably aligned orthogonally in relation to a two-dimensional extent of the fiber composite fabric. The challenge when separating a dry fiber composite fabric is to achieve a cleaner, more manageable cut. This means in particular that the cut edges are less or not frayed and/or stuck together and/or discolored, so that satisfactory or at least improved infusion is possible after that.

The separating and/or cutting and/or sawing of fiber composite fabrics comprises in particular the breaking of fibers arranged in the fiber composite fabric.

Apart from providing the aforementioned dry fiber composite fabric, a separating device is provided. The separating device is in particular designed such that it can move the separating element substantially in a translational movement. Furthermore, the separating device is preferably designed to provide a sufficient stroke, so that the stroke provided by the separating device is greater than the tooth tip spacing of two adjacent teeth of the toothing. Furthermore, the separating device is preferably designed in such a way that it makes it possible to separate a fiber composite fabric with a defined height, in that the separating device has a suitable cutting height, for example of at least 150 mm, in particular of at least 180 mm or of at least 200 mm. The cutting height here is the maximum height of a cut item, for example a fiber composite fabric, that can be separated by the separating device. Furthermore, for example, the fiber composite fabric has a height of greater than 30 mm, greater than 50 mm, greater than 75 mm or greater than 90 mm.

The substantially translational movement is understood here as meaning in particular a translational relative movement between the separating element and the dry fiber composite fabric to be separated, in particular in a direction of movement substantially orthogonal to the two-dimensional extent of the fiber composite fabric. Furthermore, the substantially translational movement is understood here as meaning in particular an oscillating movement, in particular an up and down movement. Preferably, the separating element, in particular a distal end of the separating element, is guided between an upper reversal point and a lower reversal point in the direction of the direction of movement. At the reversal points, the separating element preferably has in each case a speed in its direction of movement of zero. Between the upper reversal point and the lower reversal point there is a distance that preferably corresponds to the stroke.

The separating represents in particular a combination of a cutting movement and an advancing movement. Both during the cutting movement and during the advancing movement, the separating element and the dry fiber composite fabric preferably move relatively in relation to one another. Preferably, the separating element moves in one direction of movement, while the separating device moves through the fiber composite fabric in one direction of movement. The advancing direction may also be provided by the fiber composite fabric being moved in a direction that is aligned oppositely to the advancing direction. Preferably, the moving direction and the advancing direction are aligned substantially orthogonally in relation to one another.

Preferably, a substantially translational movement comprises a translational cutting movement and furthermore preferably also substantially a translational advancing movement. The cutting movement is preferably performed substantially parallel to the height of the fiber composite fabric to be separated. The advancing movement is preferably performed substantially parallel to the two-dimensional extent of the fiber composite fabric to be separated.

When separating with a substantially translational movement, it is in particular a discontinuous translational movement, in particular a discontinuous translational cutting movement, for example in the form of an up and down movement, and preferably not a continuous movement, in particular not a continuous circular movement, as occurs for example on a circular saw, chainsaw and/or bandsaw. A substantially translational advancing movement is preferably a substantially continuous movement. Preferably, an advancing direction angle in the stroke is substantially constant over the cut height, in particular by contrast with a circular cutting movement, for example of a circular saw, chainsaw and/or bandsaw, where the advancing direction angle is different over the cutting height.

A substantially orthogonal alignment of the separating element in relation to the two-dimensional extent of the fiber composite fabric and/or a substantially translational cutting movement substantially parallel to the height of the fiber composite fabric to be separated and/or a substantially translational advancing movement substantially parallel to the two-dimensional extent of the fiber composite fabric to be separated preferably also comprises during the separating a temporary relative tilting of the dry fiber composite fabric and of the separating element in relation to one another.

The separating is performed according to the invention with a separating element, which has a toothing with a wave profile. The separating element preferably has a two-dimensional extent between a proximal end and a distal end and a thickness orthogonal to the two-dimensional extent. Consequently, the separating element preferably has two edges, which run parallel to a longitudinal extent from the proximal end to the distal end. The distance between the two edges is the width of the separating element. The two-dimensional extent is accordingly preferably formed by the longitudinal extent and the width. The toothing is preferably arranged on at least one of these edges. From the proximal end to the distal end, the separating element also has a longitudinal axis, which runs orthogonally in relation to the thickness and to the width.

The toothing has a plurality of teeth. In the case of a wave profile, the teeth are formed as waves, so that a tooth may for example have partially or completely the geometry of a half-circle or a half-ellipse. The teeth of a wave profile may however also for example be formed as pointed with a very small tooth tip radius. The teeth have a tooth tip, which is preferably facing away from the longitudinal axis of the separating element. Opposite from the tooth tip, a tooth has a tooth root, which is preferably facing the longitudinal axis of the separating element. A tooth extends from its tooth root to its tooth tip.

With the tooth root, a tooth is arranged on a tooth root line. Different configurational variants are possible for the tooth root line, in particular with respect to the geometry along the edge of the separating element. In the simplest configurational variant of the tooth root line, it may be formed as a straight line, which is arranged parallel to the longitudinal axis of the separating element. The teeth are then arranged next to one another with respect to the longitudinal axis of the separating element. Furthermore, the straight tooth root line may be tilted about an axis parallel to the thickness of the separating element. Furthermore, the tooth root line may comprise curves, wherein in particular a sinusoidal profile of the tooth root line is preferred, so that the tooth root line may also assume a wave-like profile. Preferably, the high points of the sinusoidal profile can be joined by a straight line, which runs substantially parallel to the longitudinal extent of the separating element. The wave-shaped profile of the tooth root line preferably takes place in a plane that extends two-dimensionally parallel to the two-dimensional extent of the separating element. The waves formed by the tooth root line are preferably not formed as teeth and therefore also do not have any teeth tips. Consequently, it is also not possible to determine a tooth tip spacing between two adjacent waves of the tooth root line.

The tooth tip is preferably the location of a tooth that is at the greatest distance from the tooth root line. From a location at the tooth root, a tooth tip straight line that runs through the tooth tip extends orthogonally in relation to the tooth root line. In the direction of the tooth tip straight line, the distance between the tooth root and the tooth tip is the tooth height.

In a preferred configurational variant, the teeth of the toothing have in each case the same tooth height. In this configurational variant, the tooth tip spacing is the size of the distance between two adjacent tooth tips. In this configurational variant, the tooth tip spacing can likewise be determined by the distance between the tooth tip straight lines of two adjacent teeth at the height of the tooth tips. This determination of the tooth tip spacing is independent of the geometry of the tooth root line. In the case of a straight tooth root line, there is in addition the possibility of determining the tooth tip spacing by way of the orthogonal distance between the tooth tip straight lines of two adjacent teeth.

This determination of the tooth tip spacing can in most cases also be used when two adjacent teeth do not have the same tooth height. Since the deviations of the aforementioned possibilities from the actual tooth tip spacing would be negligible. If the deviation is not negligible, the tooth tip spacing is approximated on the basis of the distance between the tooth tip straight lines of two adjacent teeth. Here, the tooth tip spacing is determined by the distance between two tooth tip straight lines at certain locations, wherein these locations are at a distance from the tooth root line that corresponds to half the sum of the tooth tip heights. This location is accordingly halfway between a first tooth tip and a second tooth tip in the direction of the tooth tip straight line.

The tooth tip spacing preferably lies in a range between 0.1 mm and 10 mm, furthermore preferably in a range between 0.5 mm and 5 mm, wherein in particular a tooth spacing of between 1 mm and 3 mm is preferred.

The separating element may furthermore also comprise two separating sub-elements, which are preferably arranged parallel to one another, wherein the toothings of the two separating sub-elements are arranged on the same side with respect to the separating device. Furthermore, the translationally guided separating sub-elements are preferably guided running counter to one another. Running counter to one another preferably means that the separating sub-elements have substantially a direction of movement that is opposed to the direction of movement of the other separating sub-element respectively. For example, a first separating sub-element moves in the direction of an upper reversal point and a second separating sub-element moves in the direction of a lower reversal point. Such an arrangement provides the possibility of reducing the tooth tip spacing effective at the fiber composite fabric.

The toothing on the separating element may be arranged either on one side or on two sides. A one-sided toothing is preferably distinguished by the fact that the toothing takes place substantially by arranging notches and/or other recesses or depressions on one side of the separating element in the region of an edge. A two-sided toothing is preferably distinguished by the fact that the toothing takes place substantially by arranging notches and/or other recesses or depressions on two sides of the same edge of the separating element. Furthermore, the toothing may comprise a relief, which is also referred to as a crosscut. A relief is preferably distinguished by the fact that the teeth of the toothing are at a distance from one another in the direction of the thickness of the separating element.

The toothing preferably extends on the edge of the separating element, wherein the edge preferably has a longitudinal extent that is aligned substantially parallel to the stroke. The separating of the dry fiber composite fabric is performed with this toothed edge of the separating element. The translational movement of the toothing preferably takes place substantially parallel to the height of a fiber composite fabric to be separated. The translational movement is performed with a stroke, so that during the separation the separating element has an upper reversal point and a lower reversal point. The distance between the upper reversal point and the lower reversal point is the stroke. The stroke may for example assume values of between 2 mm and 50 mm. In particular, a stroke in a range between 5 mm and 20 mm is preferred. A stroke between 10 mm and 12 mm is particularly preferred. Preferably, the stroke is of a smaller size than the height of the fiber composite fabric. Alternatively, the stroke is preferably of a size that is the same as or greater than the height of the fiber composite fabric.

According to the invention, the separating is performed by a stroke that is of a greater size than the tooth tip spacing of two adjacent teeth. Furthermore, the separating is preferably performed by an advancement of the separating device, wherein the advancing direction is aligned in the direction of the cut to be carried out in the fiber composite fabric. The advancement may also be executed by the fiber composite fabric, in that it is moved counter to the direction of the cut edge to be introduced.

As a result of the multiplicity of fabric layers arranged one on top of the other, a multiplicity of fibers are to be severed substantially at the same time. In the case of fiber composite fabrics that have a height of at least 30 mm, at least 40, at least 50 mm, at least 90 mm, or at least 150 mm, for example about 11 layers every 10 mm of height are arranged one on top of the other. A fiber composite fabric with a height of 90 mm accordingly comprises for example about 100 fabric layers arranged one on top of the other. The weight of a fabric layer may range from a few grams per square meter to over 1000 grams per square meter. For example, fabric layers with a weight of 1230 grams per square meter are possible.

The method according to the invention for separating a dry fiber composite fabric provides the possibility of separating a fiber composite fabric, wherein in particular the cut edges are less frayed, substantially no fusing of the individual fibers takes place and consequently an infusion of the fiber composite fabric can be improved. The method is particularly suitable in particular for fiber composite fabrics with a height of more than 30 mm.

The production of fiber composite materials is generally complex and involves a high proportion of manual activity. For example, for producing certain geometries, the semifinished fiber composite products can be placed in molds. For rotationally symmetrical components, it is also possible to apply the principle of fiber winding or fiber fabric winding, known as preform winding, which can increase the rate of production of fiber composite fabrics considerably. The fiber fabric winding is performed for example by winding fabric layers onto a core.

Fiber fabric winding is therefore restricted primarily to creating rotationally symmetrical fiber composite fabrics. In particular, fiber fabric winding is used to create fiber composite fabrics for large components. A requirement for such components is often that the fiber composite fabric has a height of more than 30 mm, more than 40 mm, often more than 50 mm, sometimes more than 75 mm or more than 90 mm. On account of this height or thickness, it is generally scarcely possible or not possible for the fiber composite fabric to be separated or cut to size after the winding.

In a preferred embodiment, the provision of a fiber composite fabric comprises the provision of a fiber composite fabric created by fiber fabric winding, preferably a rotationally symmetrical fiber composite fabric, wherein this fiber composite fabric is separated at at least one, preferably two or more, separating locations in such a way that one, two or more fiber composite fabric parts that are not rotationally symmetrical are created.

The method makes it possible in this way to create economically a fiber composite fabric that is not rotationally symmetrical, by a fiber composite fabric first being created by fiber fabric winding and after that separated or cut to size according to the required properties, preferably at separating locations lying opposite one another. A separating location may for example be a cut surface.

In a preferred configurational variant of the method, it is provided that the separating element is provided as a saw blade. A saw blade generally has a two-dimensional extent, wherein a thickness is exhibited orthogonally in relation to the two-dimensional extent. The two-dimensional extent of the saw blade additionally has a longitudinal extent and a transverse extent. The longitudinal extent is generally greater than the transverse extent by a multiple. At one or both edges that respectively run parallel to the longitudinal extent of the saw blade, the toothing is arranged. In the present case, this toothing is formed as a wave profile.

According to a particularly preferred configurational variant of the method, it is provided that the stroke runs parallel to a tooth tip joining line. A tooth tip joining line joins the tooth tips of the teeth of the toothing. A pre-requisite for this is in particular a straight tooth tip joining line, and consequently also the possibility of joining the tooth tips of the arranged teeth by a straight line. Preferably, the individual teeth or waves of the toothing are respectively formed with an equal tooth height, so that the tooth tip joining line runs parallel to a longitudinal extent of the separating element. Consequently, the longitudinal extent of the separating element is preferably likewise parallel to the stroke.

According to a particularly preferred configurational variant of the method, it is provided that the stroke is of a size equivalent to 1.5 to 20 times the tooth tip spacing. The tooth tip spacing is the spacing of the tooth tips between two adjacent teeth, so that in this configurational variant the stroke must be at least 50% greater than the tooth tip spacing or the spacing of two adjacent teeth. Furthermore, the stroke is less than twenty times the tooth tip spacing. In the case where the tooth tip spacing between adjacent teeth is not constant along the toothing, this configurational variant preferably provides that the stroke is of a size equivalent to 1.5 to 20 times the greatest tooth tip spacing of adjacent teeth along the toothing.

According to a further particularly preferred configurational variant of the method, it is provided that the stroke is of a size equivalent to 2 to 5 times the tooth tip spacing. According to a further particularly preferred configurational variant of the method, it is provided that the stroke is of a size equivalent to 15 to 20 times the tooth tip spacing. According to a further particularly preferred configurational variant of the method, it comprises providing a separating device having an electrical and/or pneumatic and/or hydraulic drive. This drive is in particular arranged in the separating device and designed to move the separating element with a stroke in a substantially translational movement.

According to a further particularly preferred configurational variant of the method, it is provided that the separating device is provided as a straight knife cutting machine. A straight knife cutting machine comprises in particular a stand, which is preferably designed to keep the straight knife cutting machine in a substantially upright position on a surface, in particular a horizontal surface, and a drive unit, which is preferably arranged and designed to guide a separating element, in particular with a translational movement. For this purpose, the straight knife cutting machine preferably has a receiving device for a separating element.

The straight knife cutting machine may preferably be configured as a hand-held device, so that the straight knife cutting machine can be moved by an operator on a surface that is preferably horizontal, for example in the direction of the advancement. In particular, such a straight knife cutting machine is used for separating an article that preferably has a substantially two-dimensional form substantially two-dimensionally parallel to a base under the straight knife cutting machine. Alternatively, the straight knife cutting machine may preferably also be moved in an automated manner, for example by means of a robot.

According to a further preferred configurational variant, it is provided that the separating device comprises a holding-down device. The holding-down device serves in particular for pressing together the fiber composite fabric in the direction of its height, in order in this way to achieve better separating. The holding-down device preferably comprises a hold-down, which furthermore is preferably adjustable in the direction of the stroke of the separating device. Furthermore, the hold-down is preferably arranged in such a way that the separating element can separate the fiber composite fabric.

According to a further preferred configurational variant, it is provided that the separating element comprises a separating element guide, which guides the separating element substantially in its translational direction. In particular, it is preferred that the separating element guide is arranged in the region of the upper reversal point and/or the lower reversal point of the separating element. The separating element guide is intended to prevent or at least reduce a deviation from a target path of movement. The separating element guide may for example reduce the so-called fluttering of a separating element. Consequently, the quality of the separation can be increased further. In addition, a separating element guide may prevent or delay the breaking off of the separating element.

According to a further preferred configurational variant, it is provided that the separating element guide comprises a fluid feeding device. The fluid feeding device may be arranged within the elements of the separating element guide and/or be arranged on outer surfaces of the elements of the separating element guide. The fluid feed may serve for feeding a fluid to the separating element for cooling the separating element, so that the separating element, and consequently also the fibers to be separated, can be at a reduced temperature. Furthermore, the fluid may serve for removing swarf and the like.

According to a further preferred configurational variant, it is provided that the separating device performs a stroke that has a frequency of >1 Hertz. In particularly preferred configurational variants, the separating device performs a stroke with a frequency of greater than 10 Hertz, wherein a frequency of between 40 Hertz and 100 Hertz is particularly preferred. Furthermore, the stroke preferably has a frequency of between 50 Hertz and 60 Hertz. In addition, frequencies of greater than 100 Hertz, greater than 200 Hertz, greater than 300 Hertz, or greater than 400 Hertz are also possible.

According to a further preferred configurational variant, it is provided that the fiber composite fabric consists of glass fibers or comprises glass fibers. A glass fiber is in particular a long thin fiber consisting of glass. These thin fibers are drawn from a glass melt during production and further processed after that to form a variety of end products. Apart from glass fibers, the fiber composite fabric may also comprise further inorganic fibers, such as for example basalt fibers or steel fibers, but also comprise organic fibers such as for example aramid and/or carbon and/or polyester fibers. Such fibers, in particular glass fibers, have a particularly high strength, so that the separating of an individual fiber, and in particular the separating of a fiber composite fabric comprising one of these fibers, is made significantly more difficult. In addition, the fiber composite fabric may contain a binder, such as for example an adhesive.

According to a further preferred configurational variant of the method, it is provided that the fiber composite fabric has a height in the direction of the stroke and this height is 50 mm or greater. The fiber composite fabric preferably has a two-dimensional extent and, orthogonal to this two-dimensional extent, a height. In addition, this fiber composite fabric is separated, in particular by the separating element, which performs a stroke that is aligned parallel to this height. In addition, the fiber composite fabric has in the direction of its height a dimension or an extent of 50 mm or more. This 50 mm height may relate to a single point of the fiber composite fabric and/or to a number of points or locations of the fiber composite fabric. Preferably, the indication of a height means that the fiber composite fabric has this height at more than 50% of its two-dimensional extent, in particular at more than 75% or more than 90% of its two-dimensional extent.

According to a further preferred configurational variant of the method, it is provided that the fiber composite fabric has a height in the direction of the stroke and this height is 75 mm or greater. According to a further configurational variant of the method, it is provided that the fiber composite fabric has a height in the direction of the stroke and this height is 90 mm or greater.

According to a further particularly preferred configurational variant of the method, it is provided that the toothing has a constant tooth tip spacing. A constant tooth tip spacing means that the tooth tips of the teeth, here the waves, are at the same distance from one another. In particular, a constant tooth tip spacing means that a large number or a majority of the teeth arranged have a constant tooth tip spacing. For example, it is also possible that individual teeth of this toothing, for example the first tooth and/or the last tooth of the toothing, that is to say those teeth that only have an adjacent tooth on one side, have a tooth tip spacing that does not correspond to the tooth tip spacing of the large number or majority of the teeth.

In a further particularly preferred configurational variant of the method, it is provided that the toothing has a tooth tip spacing of between 0.5 mm and 2.5 mm, preferably between 0.8 mm and 2 mm, in particular between 1 mm and 1.5 mm. According to a further preferred configurational variant of the method, it is provided that the toothing has a varying tooth tip spacing. A varying tooth tip spacing means in particular that the already previously defined tooth tip spacings are not constant. Preferably, in this configurational variant the teeth arranged on the toothing are arranged on the basis of the chaos principle, so that no systematic pattern can be found in the arrangement. Alternatively, the arrangement of the teeth preferably has a system, which however does not provide a constant tooth tip spacing.

According to a further preferred configurational variant of the method, it is provided that the toothing has an alternating tooth tip spacing. Alternating preferably means following one another somewhat more than once regularly in alternation. An alternating tooth tip spacing accordingly means that the toothing has two, three or more different tooth tip spacings. These different tooth tip spacings may be repeated in any desired sequence, preferably with an evident regularity.

According to a further preferred configurational variant of the method, it is provided that the separating begins at an edge of the fiber composite fabric. Preferably, the separating therefore begins from an outer side of the fiber composite fabric. Furthermore, the fiber composite fabric may preferably also have within its two-dimensional extent an edge from which the separating can begin. The edge is to be understood as meaning in particular a border or an outer delimitation of the fiber composite fabric.

In a further particularly preferred configurational variant of the method, it is provided that the separating begins from a hole in the fiber composite fabric. For example, this hole may be provided in the fiber composite fabric specifically for the separating process and/or this hole has been introduced for structural design reasons. Alternatively, the hole is introduced as a further preliminary step of the method and is preferably likewise performed with the separating device.

According to a further aspect of the present invention, the object stated at the beginning is achieved by the use of a separating device for separating a dry fiber composite fabric with a multiplicity of fabric layers arranged one on top of the other, comprising a separating element with a toothing, wherein the toothing has a wave profile with a plurality of teeth, wherein the separating element is moved in a translational manner with a stroke, wherein the stroke is greater than a tooth tip spacing of two adjacent teeth of the toothing.

According to a further aspect of the present invention, the object stated at the beginning is achieved by a wind power installation with at least one rotor blade, wherein the rotor blade comprises a fiber composite fabric that has been separated by a method according to the aforementioned configurational variants. In the operationally ready rotor blade, the fiber composite fabric preferably does not take the form of a dry fiber composite fabric, but rather a fiber composite material which comprises the fiber composite fabric and a matrix, wherein the matrix has preferably been introduced by an infusion and furthermore is preferably cured. The fiber composite material created with the separated, dry fiber composite fabric is distinguished in particular by a higher proportion of glass fibers in the region of the cut edge. Furthermore, the cut edge is distinguished by individual fibers, for example glass fibers, or elementary fibers, that have been drawn out from the fabric layers and/or from individual rovings during the separation. In addition, the cut edge created by the method according to the invention is distinguished by the fact that fiber fragments and/or dust of the fiber material (for example glass dust) is or are evident at the cut edge, in particular also between the fabric layers (at least to a greater extent than in the case of fiber composite components that have not been cut but instead produced directly as separate parts).

For further details, configurational variants and configurational details of these further aspects and their possible developments, reference is also made to the previous description of the corresponding features and developments of the method for separating a dry fiber composite fabric.

Preferred embodiments of the invention are explained by way of example on the basis of the accompanying figures, in which:

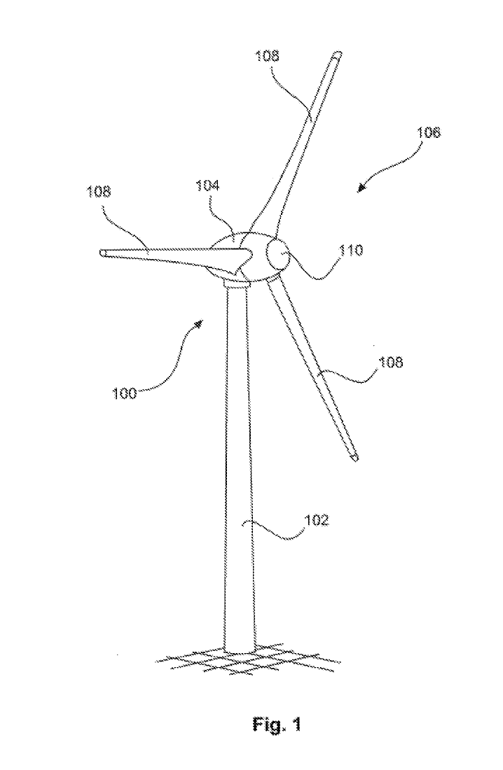

FIG. 1: shows a schematic view of an embodiment given by way of example of a wind power installation;

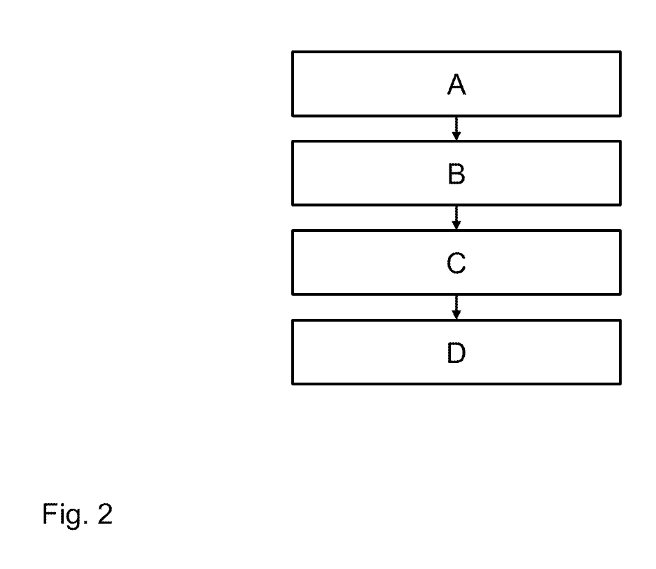

FIG. 2: shows an embodiment given by way of example of the method according to the invention as a schematic flow diagram;

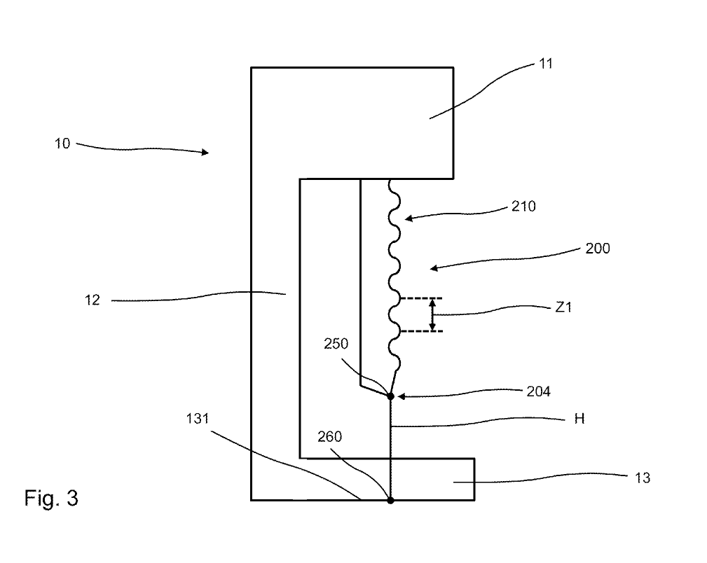

FIG. 3: shows a side view of an embodiment given by way of example of a separating device;

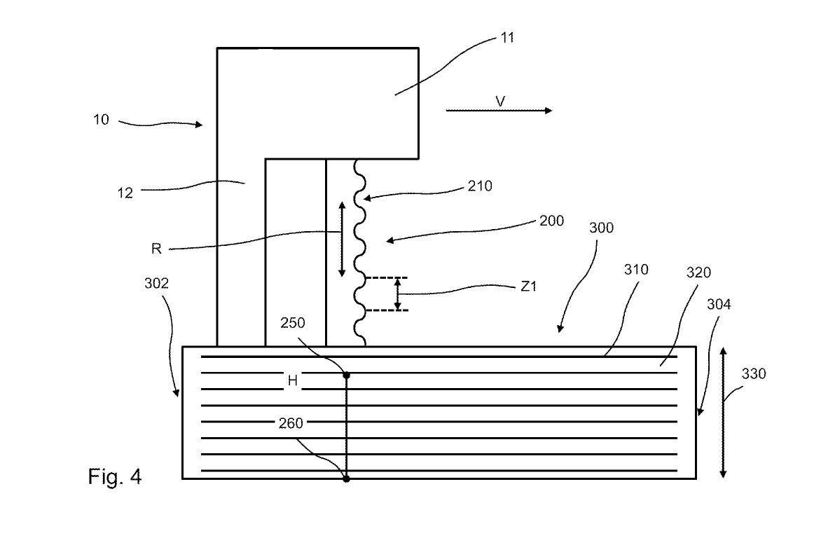

FIG. 4: shows a separating device according to FIG. 3 with an embodiment given by way of example of a fiber composite fabric;

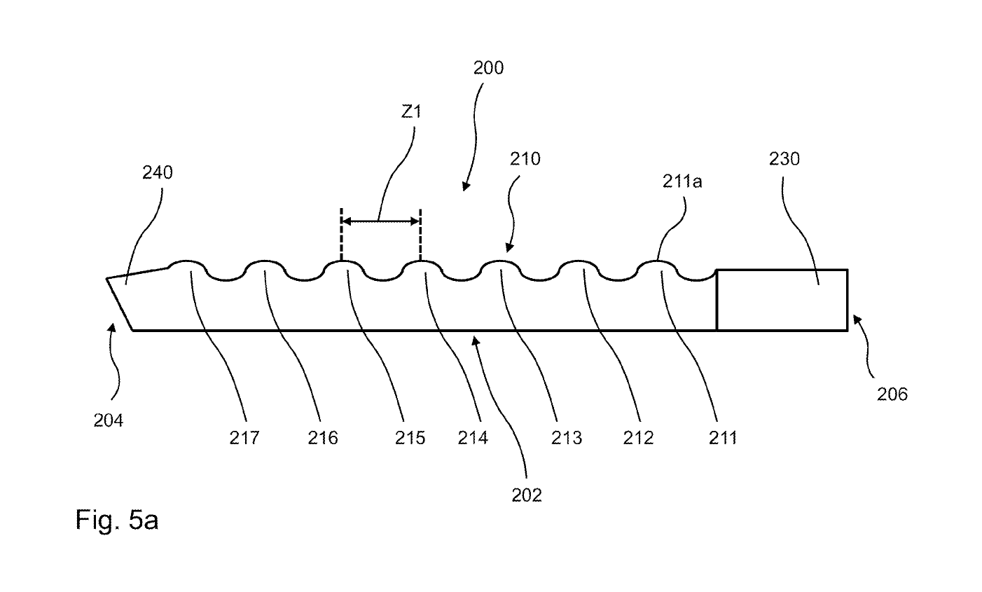

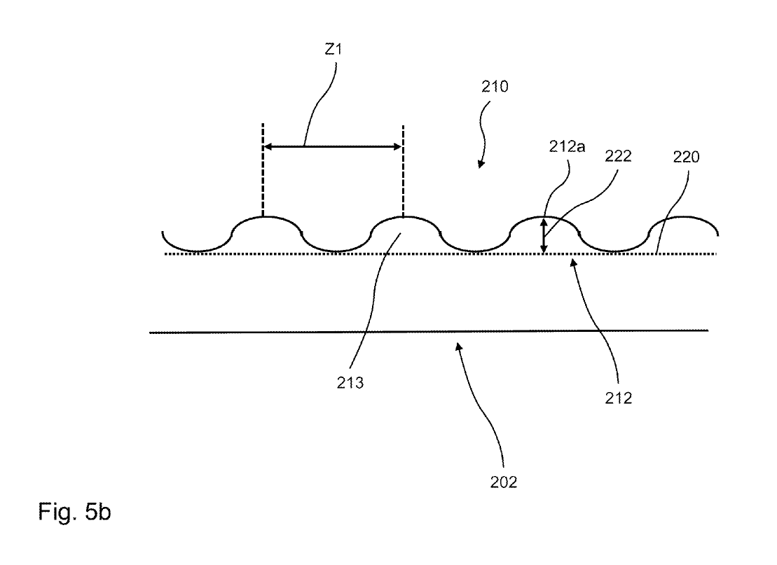

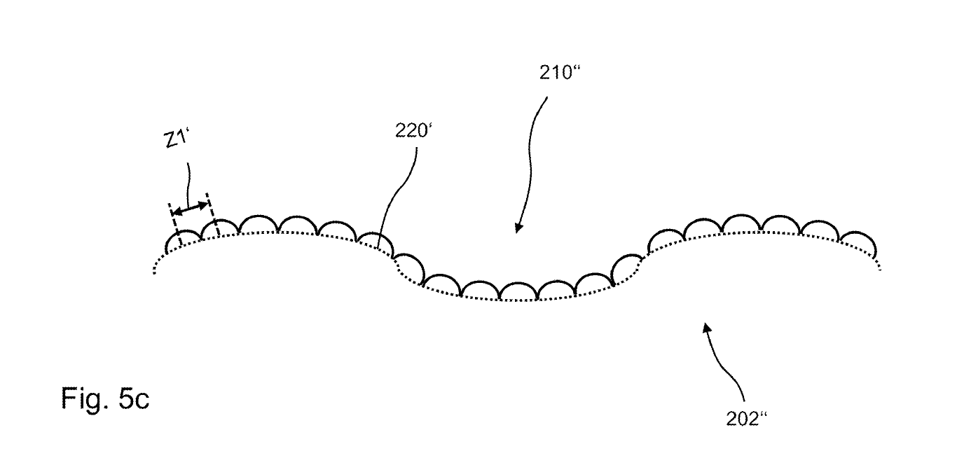

FIG. 5a: shows a side view of a schematic embodiment given by way of example of a separating element;

FIG. 5b: shows a view of a detail of the separating element according to FIG. 5a;

FIG. 5c: shows a view of a detail of a schematic embodiment given by way of example of a toothing;

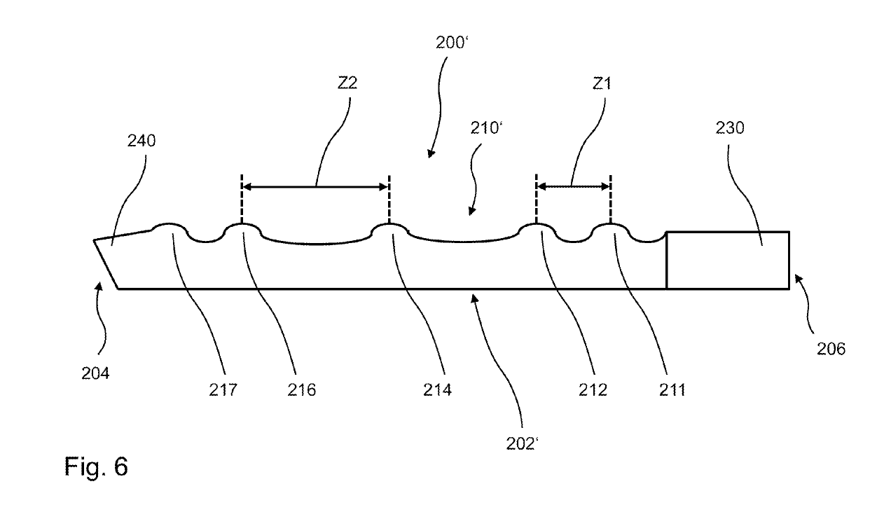

FIG. 6: shows a side view of a further schematic embodiment given by way of example of a separating element;

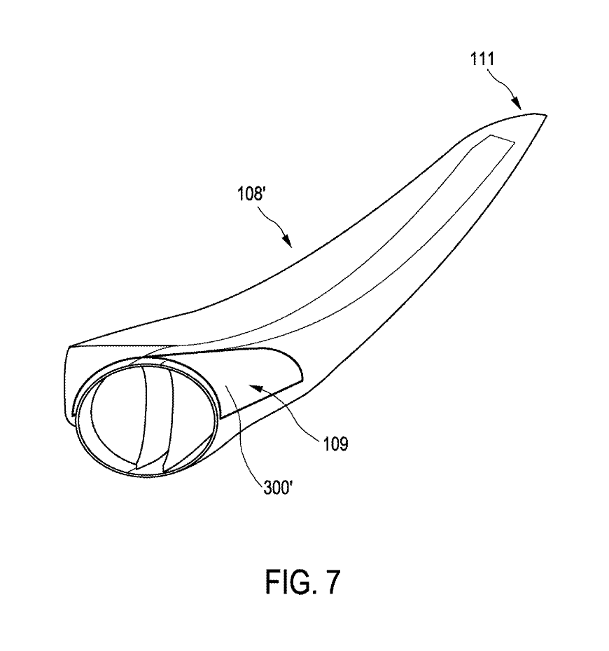

FIG. 7: shows a three-dimensional view of an embodiment given by way of example of a rotor blade; and

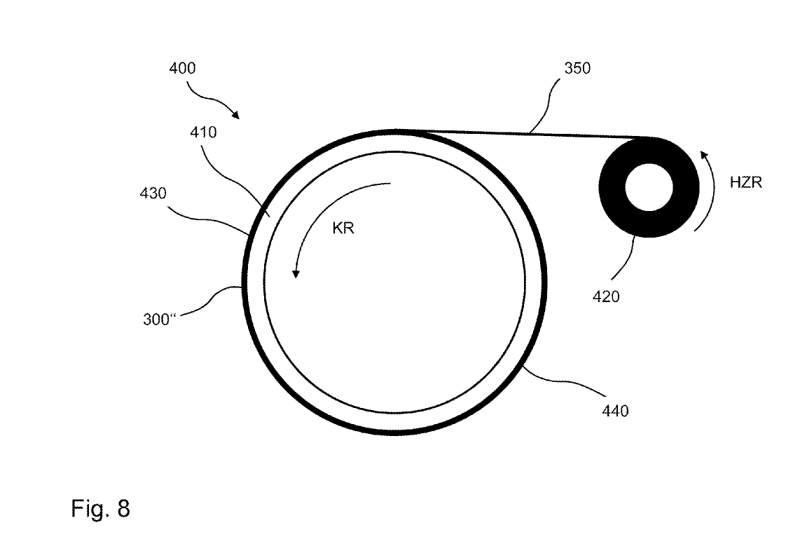

FIG. 8: shows a schematic view of an embodiment given by way of example of a preform winding.

In the figures, elements that are the same or substantially functionally the same or similar are denoted by the same reference signs.

FIG. 1 shows a schematic view of an embodiment given by way of example of a wind power installation. FIG. 1 shows in particular a wind power installation 100 with a tower 102 and a nacelle 104. Arranged on the nacelle 104 is a rotor 106 with three rotor blades 108 and a spinner 110. During operation, the rotor 106 is set in a rotary motion by the wind, and thereby drives a generator in the nacelle 104.

FIG. 2 shows an embodiment given by way of example of the method according to the invention as a schematic flow diagram. In a method step A, a dry fiber composite fabric is provided. In particular, the fiber composite fabric is provided in such a way that after that it can be separated. Preferably, the fiber composite fabric is for example provided on a table or some other substantially horizontal surface that is designed and suitable for arranging a fiber composite fabric in such a way that it can be separated with a separating device.

In particular, the fiber composite fabric is preferably arranged with its two-dimensional extent substantially horizontal. In a method step B, a separating device that is designed and arranged to separate a fiber composite fabric is provided. The separating device may for example be a straight knife cutting machine. In method steps C and D, the fiber composite fabric provided is separated with the separating device provided. The separating join in the fiber composite fabric may have a straight and/or arcuate geometry. Furthermore, the separating is preferably performed in such a way that the fiber composite fabric is separated into two or more parts with respect to its two-dimensional extent. This separating is performed in particular by method step D, in which a translational movement of a toothing of the separating element is performed on and/or in the fiber composite fabric. This translational movement of the toothing on or in the fiber composite fabric is performed according to the invention in such a way that the translationally executed stroke of the separating element is of a greater size than a tooth tip spacing of the toothing. In addition, the toothing has a wave profile with a plurality of teeth.

FIG. 3 shows a side view of an embodiment given by way of example of a separating device. The separating device 10 comprises a drive region 11 and a separating device foot 13, between which a separating device stand 12 extends on one side. The drive region 11 and the separating device foot 13 therefore project from the separating device stand 12. In addition, the drive region 11 and the separating device foot 13 project on the same side of the separating device stand 12. The separating device foot 13 has furthermore a horizontal underside 131, with which the separating device 10 can be placed on a base under it. The horizontal underside 131 of the separating device foot 13 is arranged substantially orthogonal to a vertically guided separating element 200. The vertically guided separating element 200 is arranged with one end within the drive region 11, so that the separating element 200 is located between the drive region 11 and the separating device foot 13.

The separating element 200 has a two-dimensional extent between a distal end 204 and a proximal end (not represented), which is arranged opposite from the distal end 204 with respect to the longitudinal extent. On one edge of the separating element 200, a toothing 210 is additionally arranged. The toothing 210 is arranged on the edge of the separating element 200 that is facing away from the separating device stand 12. The toothing 210 has a wave profile which has a number of teeth that have a constant tooth tip spacing Z1 in relation to their adjacent teeth. The proximal end of the separating device 10 is arranged in the drive region 11 of the separating device. This arrangement is performed in particular such that the separating device 10 with the drive region is designed to move the separating element 200 vertically in a translational manner, wherein this movement is performed in particular with a stroke H. Furthermore, this movement of the separating element 200 is performed such that the stroke H is greater than a tooth tip spacing Z1. The stroke H may extend as far as the horizontal underside 131 of the separating device foot 13. Alternatively, a lower reversal point of the stroke is at a distance from the horizontal underside 131 in the direction of the drive region 11. In FIG. 3, the separating element 200 is at an upper reversal point 250 of the stroke H. The lower reversal point 260 of the stroke is level with the horizontal underside 131 of the separating device foot 13.

FIG. 4 shows a separating device according to FIG. 3 with an embodiment given by way of example of a dry fiber composite fabric. The fiber composite fabric 300 comprises fibers 310 and also a binder 320 arranged between the fibers 310. The arrangement one on top of the other, shown in particular in FIG. 3, of fibers 310 arranged substantially vertically one on top of the other produces a height 330 of the fiber composite fabric.

The separating device 10 is designed in particular such that it can sever the fiber composite fabric 300 from a first end 302 to a second end 304. This is performed by a substantially translational movement of the separating element 200 on and/or in the dry fiber composite fabric in a direction of movement R with a stroke that is greater than a tooth tip spacing of two adjacent teeth of the toothing. In addition, the separating element 200 is moved in a direction of movement R while the separating device 10 moves through the fiber composite fabric with the advancing direction V.

Alternatively, the advancing direction V may also be provided by the fiber composite fabric 300 being moved in a direction that is aligned oppositely to the depicted advancing direction V. The distal end 204 (see FIG. 3) of the separating element 200 is guided between an upper reversal point 250 and a lower reversal point 260 in the direction of the direction of movement R. At the reversal points 250, 260, the separating element has in each case a speed in its direction of movement R of zero. Between the upper reversal point 250 and the lower reversal point 260 there is a distance that corresponds to the stroke H. In FIG. 4 the stroke and the upper and lower reversal points 250, 260 are only represented schematically, in order to illustrate the form of movement of the separating element in or on the fiber composite fabric 300. Preferably, the stroke is smaller than a height of the fiber composite fabric 330. Alternatively, the stroke is preferably equal to the height or greater than the height of the fiber composite fabric 330.

FIG. 5a shows a side view of an embodiment given by way of example of a separating element. The separating element 200 extends from a proximal end 206 to a distal end 204. In a region adjoining the proximal end 206, the separating element 200 has a fastening portion 230. This fastening portion 230 is arranged and designed to be arranged on a separating device 10 in such a way that the separating element 200 can be moved with a translational movement in a direction of movement and with a stroke. For this, the fastening portion 230 is for example clamped in a receiving device designed for this of the drive region 11. In a region adjoining the distal end 204 of the separating element 200, the knife tip 240 is arranged. Between the knife tip 240 and the fastening portion 230 there is the shaft 202. The shaft 202 has a first side, on which a toothing 210 is arranged. On a side of the shaft 202 opposite from this, the shaft has a straight edge.

In the present case, the toothing 210 has a wave profile. The toothing 210 has a first tooth 211, a second tooth 212, a third tooth 213, a fourth tooth 214, a fifth tooth 215, a sixth tooth 216 and a seventh tooth 217. Each tooth has a tooth tip, the first tooth tip 211a, belonging to the first tooth 211, being shown by way of example. Between the teeth there are teeth interspaces, which in the present case are formed as a wave trough. In addition, a tooth tip spacing Z1 extends over the shortest path between two adjacent tooth tips. The separating element 200 given by way of example has here a constant tooth tip spacing Z1.

FIG. 5b shows a view of a detail of the separating element according to FIG. 5a. The location of a tooth that is at the greatest distance from the tooth root line 220 in the orthogonal direction is referred to as the tooth tip. The second tooth 212 has for example the tooth tip 212a. Between the tooth root line 220 and the tooth tip 212a there extends the tooth height 222. Over the shortest path between the tooth tips of two adjacent teeth there extends the tooth tip spacing Z1.

FIG. 5c shows a view of a detail of a schematic embodiment given by way of example of a toothing. Arranged on the shaft 202″ is a toothing 210″, which has a tooth root line 220′. In this embodiment, the tooth root line 220′ is not a straight line, but instead has a sinusoidal profile. The toothing 210″ has a multiplicity of teeth, the tooth roots of which are arranged on the tooth root line 220′. In addition, the tooth tips of the teeth are at a distance from one another that corresponds to the tooth tip spacing Z1′.

FIG. 6 shows a side view of a further embodiment given by way of example of a separating element. The separating element 200′ differs from the previously described separating element 200 in particular in that it has a different toothing 210′. In particular, this toothing 210′ is distinguished by the fact that it has a first tooth tip spacing Z1 and a second tooth tip spacing Z2. The separating element 200′ comprises a first tooth 211, a second tooth 212, a fourth tooth 214, a sixth tooth 216 and a seventh tooth 217. Between the tooth tips of the first tooth 211 and of the second tooth 212 and also between the tooth tips of the sixth tooth 216 and of the seventh tooth 217 there extends the first tooth tip spacing Z1. The second tooth 212 and the fourth tooth 214 and also the fourth tooth 214 and the sixth tooth 216 are at a distance from one another equivalent to a tooth tip spacing Z2. In the present case, the second tooth tip spacing Z2 is approximately twice the size of the first tooth tip spacing Z1. The present toothing 210′ therefore corresponds to an alternating toothing, since it makes the first tooth tip spacing Z1 follow successively more than once regularly in alternation.

FIG. 7 shows a three-dimensional view of an embodiment given by way of example of a rotor blade, which can be used in a wind power installation 100 as shown in FIG. 1. The rotor blade 108′ extends from a root region 109 to a tip region 111. In the root region, a fiber composite fabric 300′ has been laid, here as a preform, an infusion of this fiber composite fabric being performed after it has been laid in this way. By way of example, here the preform is therefore a laminate which, prior to infusion, has been placed into a shell in the root region. In order to provide suitable fiber composite fabrics 300′ for rotor blades 108′, in particular for their root region 109, fiber composite fabrics have to be separated, unless they are produced as half-shells. This separating may be performed by means of the method shown in FIG. 2 by steps A to D and also by means of the separating device 10 described in FIGS. 2 and 3. In particular, the separating of a fiber composite fabric 300′ for a root region 109 of a rotor blade 108′ of a wind energy installation is necessary if the semifinished product of the fiber composite fabric 300 is provided in a tubular form.

FIG. 8 shows a schematic view of an embodiment given by way of example of a preform winding. The fiber composite fabric production device 400 comprises a core 410, onto which a fabric 350 is wound from a semifinished fabric product 420. The core 410 moves for example in a core direction KR and the semifinished fabric product 420 moves in a semifinished product direction HZR. Consequently, a fiber composite fabric 300″ is wound up on the core 410. In particular after the production of the fiber composite fabric 300″, the core is removed. In order then to separate this tubular, dry fiber composite fabric 300″ in such a way that it can for example be inserted into a rotor blade 108′, in particular into its root region 109, this fiber composite fabric 300″ must preferably be correspondingly cut to size. For this purpose, the tubular fiber composite fabric is preferably severed at two separating locations 430, 440, preferably lying substantially opposite one another. This cutting to size may be performed by the method according to the invention.

In particular, the method according to the invention allows a precise cutting to size of the fiber composite fabric to be performed, and in addition a good edge quality or cut-edge quality to be achieved. This good edge or cut-edge quality makes trimming of the fiber composite fabric easier, whereby in particular the costs and the necessary use of personnel are reduced and improved infusion is made possible. In addition, tubular semifinished products can be produced with a great height for fiber composite fabrics very quickly by the fiber composite fabric production device 400, and after that cut to size. Thus, the cut surfaces are in particular free from fraying, or at least less frayed, and the fibers adjacent to the cut surface are not fused, or at least to a reduced extent. Consequently, the costs for a rotor blade of a wind power installation can be reduced significantly.

Reference signs

| | |
|---|---|
| 10 | separating device |
| 11 | drive region of the separating device |
| 12 | separating device stand |
| 13 | separating device foot |
| 100 | wind power installation |
| 102 | tower |
| 104 | nacelle |
| 106 | rotor |
| 108, 108′ | rotor blades |
| 109 | root region |
| 110 | spinner |
| 111 | tip region |
| 131 | lower surface of the separating device foot |
| 200, 200′ | separating element |
| 202, 202′, 202″ | shaft |
| 204 | proximal end |
| 206 | distal end |
| 210, 210′, 210″ | toothing |
| 211 | first tooth |
| 211a | first tooth tip |
| 212 | second tooth |
| 213 | third tooth |
| 214 | fourth tooth |
| 215 | fifth tooth |
| 216 | sixth tooth |
| 217 | seventh tooth |
| 220, 220′ | tooth root line |
| 230 | fastening portion |
| 240 | knife tip |
| 300, 300′, 300″ | fiber composite fabric |
| 302 | first end of fiber composite fabric |
| 304 | second end of fiber composite fabric |
| 310 | fiber |
| 320 | binder |
| 330 | height of fiber composite fabric |
| 350 | fabric |
| 400 | fiber composite fabric production device |
| 410 | core |
| 420 | semifinished fabric product |
| A | method step |
| B | method step |
| C | method step |
| D | method step |
| H | stroke of the knife |
| HZR | semifinished product direction of rotation |
| KR | core direction of rotation |
| R | direction of movement of knife |
| V | advancing direction of separating device |
| Z1, Z1′ | first tooth tip spacing |
| Z2 | second tooth tip spacing |

1. A method for separating a dry fiber composite fabric with a plurality of fabric layers arranged one on top of the other, the method comprising:
separating the dry fiber composite fabric using a separating device that comprises a separating element with a toothing, wherein the toothing has a wave profile with a plurality of teeth,
wherein the separating comprises a substantially translational movement of the toothing on and/or in the dry fiber composite fabric with a stroke that is greater than a tooth tip spacing of two adjacent teeth of the toothing.

2. The method as claimed in claim 1, comprising:
prior to separating, winding the dry fiber composite fabric, and
wherein separating comprises separating the dry fiber composite fabric at at least one separating location in such a way that at least one fiber composite fabric part that is not rotationally symmetrical is created.

3. The method as claimed in claim 1, wherein the separating element is a saw blade.

4. The method as claimed in claim 1, wherein the stroke is of a size equivalent to 1.5 to 20 times the tooth tip spacing.

5. The method as claimed in claim 1, wherein the separating device has an electrical, pneumatic, or hydraulic drive.

6. The method as claimed in claim 1, wherein the separating device is a straight knife cutting machine.

7. The method as claimed in claim 1, wherein using the separating device comprises using a holding-down device to hold the dry fiber composite fabric.

8. The method as claimed in claim 1, wherein the separating element comprises a separating element guide configured to guide the separating element in the substantially translational movement.

9. The method as claimed in claim 1, wherein the fiber composite fabric includes glass fibers.

10. The method as claimed in claim 1, wherein the fiber composite fabric has a height in a direction of the stroke, wherein the height is 30 mm or greater.

11. The method as claimed in claim 1, wherein the toothing has a constant tooth tip spacing.

12. The method as claimed in claim 1, wherein the toothing has a varying or an alternating tooth tip spacing.

13. The method as claimed in claim 1, wherein the separating begins at an edge of the fiber composite fabric, and/or from a hole in the fiber composite fabric.

14. A separating device for separating a dry fiber composite fabric with a multiplicity of fabric layers arranged one on top of the other, the separating device comprising:
a separating element with a toothing,
wherein the toothing has a wave profile with a plurality of teeth,
wherein the separating element is moved in a translational manner with a stroke, and
wherein the stroke is greater than a tooth tip spacing of two adjacent teeth of the toothing.

15. A wind power installation with at least one rotor blade, wherein the rotor blade comprises a fiber composite fabric that has been separated by the method as claimed in claim 1.

16. The method as claimed in claim 4, wherein the stroke is of a size equivalent to 2 to 5 times the tooth tip spacing or a size equivalent to 15 to 20 times the tooth tip spacing.

17. The method as claimed in claim 11, wherein the tooth tip spacing is between 0.5 mm and 2.5 mm.

18. The method as claimed in claim 17, wherein the tooth tip spacing is between 1 mm and 1.5 mm.

19. The method as claimed in claim 1, wherein the separating element guide comprises a fluid feeding device.
